(19) United States
(12) Patent Application Publication
(10) Pub. No.: US 2013/0094753 A1
(43) Pub. Date: Apr. 18, 2013

(54) FILTERING IMAGE DATA

(71) Applicants: Shane D. Voss, Fort Collins, CO (US); Oscar Zuniga, Fort Collins, CO (US); Jason E. Yost, Windsor, CO (US); Kevin Matherson, Windsor, CO (US); Tanvir Islam, Fort Collins, CO (US)

(72) Inventors: Shane D. Voss, Fort Collins, CO (US); Oscar Zuniga, Fort Collins, CO (US); Jason E. Yost, Windsor, CO (US); Kevin Matherson, Windsor, CO (US); Tanvir Islam, Fort Collins, CO (US)

(21) Appl. No.: 13/275,816

(22) Filed: Oct. 18, 2011

(51) Int. Cl. G06K 9/00

(52) U.S. Cl. 382/154

(57) ABSTRACT

Systems, methods, and machine-readable and executable instructions are provided for filtering image data. Filtering image data can include determining a desired depth of field of an image, determining a distance between a pixel of the image and the desired depth of field. Filtering image data can also include adjusting a contrast of the pixel in proportion to a magnitude of a weight of the pixel, wherein the weight is based on the distance.

### BACKGROUND

Mobile camera devices may utilize a camera lens that provides a large depth of field. A large depth of field provides for significant amount of image content at a wide depth range to be sharp. In a large depth of field image, all subjects within a wide range of distances or depths from the camera may have similar image clarity and sharpness.

A photographer may wish to capture an image that has a narrow depth of field in order to emphasize a particular subject of interest. In this case, the subject of interest within the desired depth of field may appear sharp, and the surrounding subject matter outside the desired depth of field may appear less sharp or blurry.

### BRIEF DESCRIPTIONS OF THE DRAWINGS

FIG. 1 is a flow chart illustrating an example of a method for filtering image data according to the present disclosure.

FIG. 2 illustrates a diagram of an example weighted curve according to the present disclosure.

FIG. 3 illustrates a block diagram of an example of a machine-readable medium in communication with processing resources for filtering image data according to the present disclosure.

### DETAILED DESCRIPTION

Examples of the present disclosure may include methods, systems, and machine-readable and executable instructions and/or logic. An example method for filtering image data may include determining a desired depth of field of an image, determining a distance between a pixel of the image and the desired depth of field. An example method for filtering image data may also include adjusting a contrast of the pixel in proportion to a magnitude of a weight of the pixel, wherein the weight is based on the distance.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

Image filtering is a process that may change the appearance and/or data of an original image. For example, many electronic devices utilizing software programs are able to change the appearance of an image (e.g., adjusting the contrast, changing the color of subjects, adjusting the tint, adding objects or subjects, distorting the image or subject within the image, deleting objects or subjects, darkening, and/or brightening). The changes that can be utilized may depend on the application, the desire of the person who is filtering the image, and/or the program that is filtering the image. In another example, image filtering can include subject highlighting with a narrow depth of field.

Images can be broken down into units called pixels, which are the smallest unit of the image that can be individually represented and controlled. The number of pixels that an image may contain can vary depending on a number of factors, including, but not limited to, a type of device used to capture the image, settings of the device, and/or lens quality of the device. A filter can change the properties of any number of the image pixels to produce a second image that can be similar or greatly different than the original image depending on the specifications of the filter. For example, a filter can change a very small number of pixels if the specification includes eliminating the red eye effect that is created under certain conditions. The filter may change only the few pixels that are within the red eye regions of the image and leave the rest of the image unchanged. In the example of the red eye filter, the second image that is produced after filtering may appear very similar to the original image. In contrast, other filters, such as distortion filters, can change nearly every pixel within the image to make the photograph appear very different from the original image.

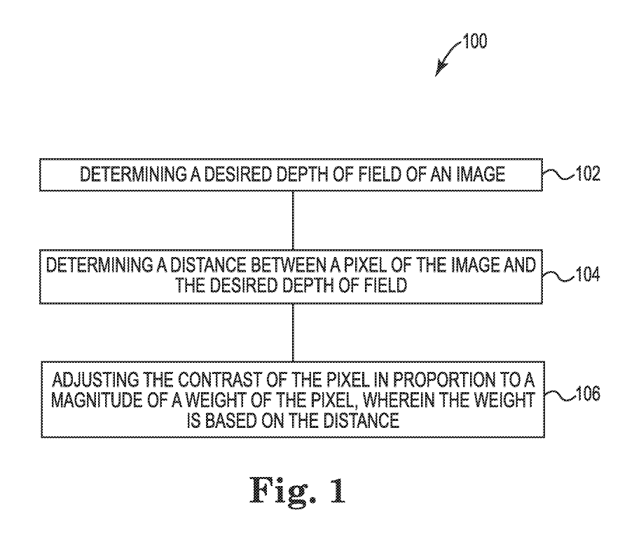

FIG. 1 is a flow chart illustrating an example of a method 100 for filtering image data according to the present disclosure. The method 100 can filter image data to produce subject highlighting with a narrow depth of field. For example, image data with a large depth of field can be filtered through method 100 to produce the appearance of a narrow depth of field.

At 102, the desired depth of field can be determined. For example, if there is a subject within the image that a photographer wishes to have highlighted, then the desired depth of field can be the pixels or a pixel contained within that subject. This determination can be based on the desires of the photographer. The subject that is chosen can be anywhere within the image and may not be the largest subject, the subject closest to the camera, or the center of the image. A desired depth of field can include a person, animal, plant, object or any other desired subject within the image that the photographer wishes to emphasize or highlight.

A depth mask can be utilized when determining a desired depth of field. A depth mask can be created by several devices, including a plenoptic camera. A depth mask may be stored within the image data and can provide information on a depth of individual pixels. Thus, the depth mask can provide information on an individual pixel's distance from where the image was captured compared to other pixels. This information can allow a user or computer to determine a distance based on an x, y, and z axis. For example, even if two pixels are relatively close in distance on the x or y axis, the same two pixels may represent different depths of the image.

The depth mask can be filtered to eliminate noise in the depth measurements and to facilitate a grouping of pixels with similar depths. The filter used on the depth mask can smooth the depth mask by eliminating the noise, while preserving the depth transitions that are not noise. An example of a filter is an edge-preserving bilateral noise filter. An example bilateral noise filter can be represented by a function. For example:

$$h ( c ) = \frac{1}{W} {\sum }_{q} [ S ( c - q ) D ( \vert d ( c ) - d ( q ) \vert ) d ( q ) ]$$

The filtered depth can be h(c), the normalization can be 1/W, where W can be the sum of the weights, Σ_{q}[s(c−q)D(|d(c)−d(q)|)], the spatial weight kernel can be S(c−q), the depth range weight kernel can be is D(|(c)−d(q)|), and the depth of a pixel can be d(q). The spatial kernel can have a parameter to set the spatial size, and the depth range kernel can have a parameter for the acceptable change in amplitude depth weight. In an example, if these conditions are used, then the neighboring depths that satisfy both of these conditions can be used in the depth mask filter (e.g. only the neighboring depths are used). The conditions can include having a depth less than the desired maximum allowed change in depth and/or having a spatial location within the desired spatial radius.

Another example filter can be obtained through an estimator given by the equation:

$$\hat{z} ( c ) = z ( c ) + \frac{1}{N} ψ ( z ( x ) - z ( c ) )$$

Wherein c can be a coordinates (e.g., row, column) position of a pixel in a mask to be de-noised, and x can represent the coordinates of a pixel inside a neighborhood [symbol] (c) of pixels centered around c. A neighborhood size can be represented by N. The depth mask function can be represented by z(c), and its filtered version by \hat{z} (c). The influence function of the estimator can be Ψ. An example influence function corresponding to the Huber estimator is:

$$ψ ( e ) = \{ \begin{matrix}e , & e ∈ [ - σ , σ ] \\ σ , & e > σ \\ - σ , & e < - σ\end{matrix}$$

Mask pixels in the neighborhood [symbol] (c), which are within a depth range [−σ, σ] relative to the center c, may be allowed to fully influence the de-noising, whereas pixels outside may be penalized by capping their influence. In response to filtering of the depth mask, the depth mask may be smooth but the depth transitions between individual pixels may be preserved along with the original image data.

In another example, the depth mask may be utilized to determine the boundaries of subjects. For example, the depth mask can be used to distinguish objects in the foreground that are closer to the camera from objects in the background that are farther away from the camera.

At 104, a distance between a pixel of the image and the desired depth of field is determined. As described above, the depth mask can distinguish objects by their distance from the camera. Thus, the depth mask can represent the z axis of an image. The distance between a pixel of the image and the desired depth of field can include the distance in relation to the z axis. For example, the distance between a subject in the foreground and a subject in the background can be the difference in their respective distances from the camera.

At 106, the contrast of a pixel can be filtered in proportion to a magnitude of the weight of the pixel, wherein the weight can be based on the distance of a pixel from the desired depth of field. Positive weights can introduce blur, and the amount of blur can be proportional to the magnitude of the weight. Negative weights can introduce sharpening, and the amount of sharpening can be inversely proportional to the magnitude of the weight. Weights with a value of zero may have no change to the contrast of the pixel. A weighted expression can be used to determine the different amounts of blur and sharpening for each pixel within the image. For example, adjusting the contrast can include blur and/or sharpening of the pixel. In another example, no changes are made to the contrast of the pixel. Contrast adjustment can be determined using a function. For example,

$$g ( c ) = f ( c ) + \frac{1}{N} [ ( f ( x ) - f ( c ) ) w ( z ( x ) - {z}_{0} ) ]$$

where c represents the coordinates (e.g., row, column) position of the pixel to be processed, and x represents the coordinates of a pixel inside a neighborhood [symbol] (c) of pixels centered around c. The neighborhood size can be represented by N. The amount of blur and sharpening can also be a function of the size of the neighborhood. The filtered pixel can be g(c), the original pixel can be f(c), and the weight w(z(x)−z₀) can be a function of the pixel's depth distance from the center of the depth of field. The depth distance for a pixel can be determined by determining its filtered depth mask value, z(x), and taking the difference between it and the center of the filtered desired depth of field, z₀. A filter depth mask value can be determined by consulting a depth mask value table.

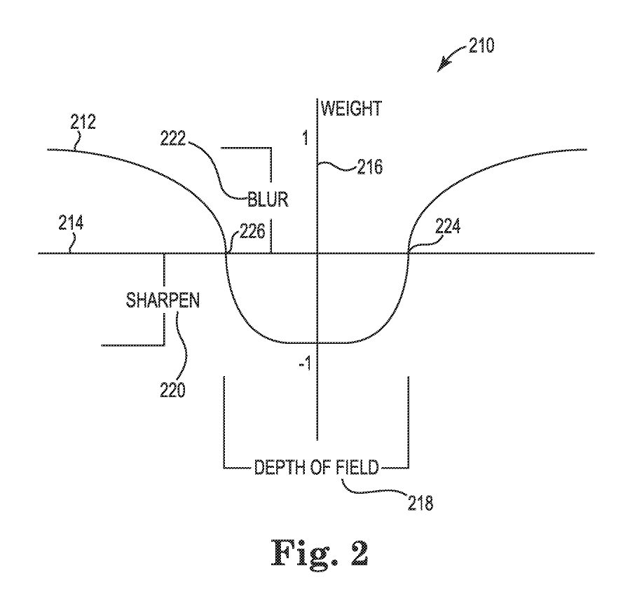

FIG. 2 illustrates a diagram 210 of an example weighted curve 212 according to the present disclosure. The curve 212 in FIG. 2 illustrates a depth of field that is sharpened. The depth of field zone 218, sharpening zone 220, and blur zone 222 are indicated. Weighted curve 212 has a distance from the center of a desired depth of field on the horizontal axis 214 and the weight value on the vertical axis 216. The portion 218 of the curve at or below zero indicates the desired depth of field centered horizontally. If negative (e.g., sharpening zone 220), it can have a sharpening factor. If zero (e.g., points 224 and 226), it can have no change to the contrast of the pixel. If positive (e.g., blurring zone 222), it can have a blurring factor. As the distance increases and weights increase in magnitude, the amount of blur can also increase. The transition from the depth of field range to increasing magnitude weight values can be smooth to provide a natural appearance. The curve can be configurable and can depend on the desired width of the depth of field and how sharply the blur increases (e.g., indicated by the slope of curve 212) as image data is located further away from the desired depth of field.

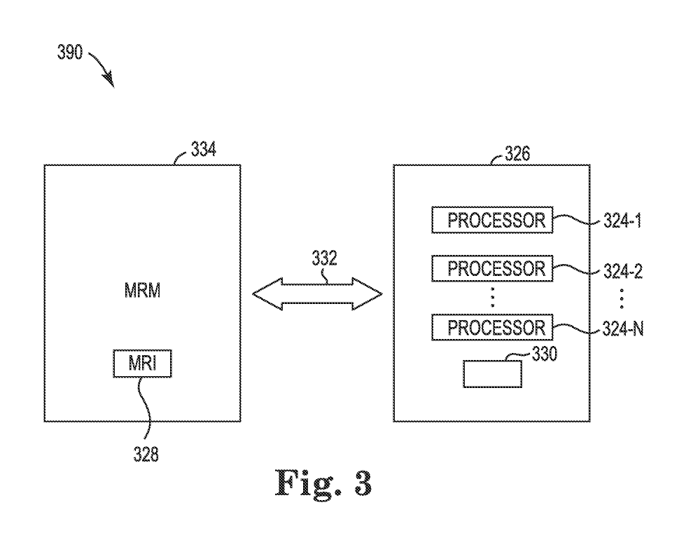

FIG. 3 illustrates a block diagram 390 of an example of a machine-readable medium (MRM) 334 in communication with processing resources 324-1, 324-2 . . . 324-N for filtering image data according to the present disclosure. MRM 334 can be in communication with a computing device 326 (e.g., Java application server, having processor resources of more or fewer than 324-1, 324-2 . . . 324-N). The computing device 326 can be in communication with, and/or receive a tangible non-transitory MRM 334 storing a set of machine readable instructions 328 executable by one or more of the processor resources 324-1, 324-2 . . . 324-N, as described herein. The computing device 326 may include memory resources 330, and the processor resources 324-1, 324-2 . . . 324-N may be coupled to the memory resources 330.

Processor resources 324-1, 324-2 . . . 324-N can execute machine-readable instructions 328 that are stored on an internal or external non-transitory MRM 334. A non-transitory MRM (e.g., MRM 334), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), flash memory, etc., as well as other types of machine-readable media.

The non-transitory MRM 334 can be integral, or communicatively coupled, to a computing device, in either in a wired or wireless manner. For example, the non-transitory machine-readable medium can be an internal memory, a portable memory, a portable disk, or a memory associated with another computing resource (e.g., enabling the machine-readable instructions to be transferred and/or executed across a network such as the Internet).

The MRM 334 can be in communication with the processor resources 324-1, 324-2 . . . 324-N via a communication path 332. The communication path 332 can be local or remote to a machine associated with the processor resources 324-1, 324-2 . . . 324-N. Examples of a local communication path 332 can include an electronic bus internal to a machine such as a computer where the MRM 334 is one of volatile, non-volatile, fixed, and/or removable storage medium in communication with the processor resources 324-1, 324-2 . . . 324-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 332 can be such that the MRM 334 is remote from the processor resources (e.g., 324-1, 324-2 . . . 324-N) such as in the example of a network connection between the MRM 334 and the processor resources (e.g., 324-1, 324-2 . . . 324-N). That is, the communication path 332 can be a network connection. Examples of such a network connection can include a local area network (LAN), a wide area network (WAN), a personal area network (PAN), and the Internet, among others. In such examples, the MRM 334 may be associated with a first computing device and the processor resources 324-1, 324-2 . . . 324-N may be associated with a second computing device (e.g., a Java application server).

The processor resources 324-1, 324-2 . . . 324-N coupled to the memory 330 can determine a distance between a first pixel and a second pixel in the image data. The processor resources 324-1, 324-2 . . . 324-N coupled to the memory 330 can also determine a weight of the second pixel. The processor resources 324-1, 324-2 . . . 324-N coupled to the memory 330 can also calculate a contrast adjustment based on the distance and the weight. Furthermore, the processor resources 324-1, 324-2 . . . 324-N coupled to the memory 330 can present results of the contrast adjustment calculation in graphical form. In addition, the processor resources 324-1, 324-2 . . . 324-N coupled to the memory 330 can filter the image data based on the presented results.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for filtering image data comprising:
determining a desired depth of field of an image;
determining a distance between a pixel of the image and the desired depth of field; and
adjusting a contrast of the pixel in proportion to a magnitude of a weight of the pixel, wherein the weight is based on the distance.

2. The method of claim 1, wherein adjusting the contrast includes at least one of blurring and sharpening the pixel.

3. The method of claim 1, wherein a positive magnitude of the weight results in a proportional amount of a blurring of the pixel.

4. The method of claim 1, wherein a negative magnitude of the weight results in a proportional amount of a sharpening of the pixel.

5. The method of claim 1, wherein a zero magnitude of the weight results in no adjustment of the contrast of the pixel.

6. A non-transitory machine-readable medium storing a set of instructions executable by a computer to cause the computer to:
filter a depth mask associated with an image;
determine a center depth of field of the image utilizing the depth mask;
determine a distance of a pixel of the image from the center depth of field;
determine a weight of the pixel based on the distance; and
implement a blurring of the pixel based on the weight.

7. The non-transitory machine-readable medium of claim 6, wherein filtering the depth mask includes a removal of image noise.

8. The non-transitory machine-readable medium of claim 6, wherein filtering the depth mask preserves a depth transition of the number of pixels.

9. The non-transitory machine-readable medium of claim 6, wherein the image includes a number of pixels, and filtering the depth mask includes grouping a portion of the number of pixels with similar depths.

10. The non-transitory machine-readable medium of claim 6, wherein the weight is a function of the pixel's depth distance from the center of the depth of field.

11. A computing system for filtering image data comprising:
a memory;
a processor resource coupled to the memory, to:
determine a distance between a first pixel and a second pixel in the image data;
determine a weight of the second pixel;
calculate a contrast adjustment based on the distance and the weight;
present results of the contrast adjustment calculation in graphical form; and
filter the image data based on the presented results.

12. The system of claim 12, wherein the first pixel is a center of a desired depth of field.

13. The system of claim 12, wherein the weight of the second pixel includes a function of the second pixel's depth distance from the first pixel.

14. The system of claim 11, wherein the graph of the function has a horizontal axis represented by the distance and a vertical axis represented by the weight.

15. The system of claim 11, wherein a negative weight introduces sharpening of the second pixel, and a positive weight introduces blurring of the second pixel.
